(19) United States
(12) Patent Application Publication
(10) Pub. No.: US 2016/0263881 A1
(43) Pub. Date: Sep. 15, 2016

(54) LABEL MEDIUM CARRYING DEVICE, PRINT DEVICE, AND LABEL MEDIUM CARRYING METHOD

(71) Applicant: Oki Data Corporation, Tokyo (JP)

(72) Inventor: Toshiyuki CHIDA, Tokyo (JP)

(21) Appl. No.: 14/947,772

(22) Filed: Nov. 20, 2015

(30) Foreign Application Priority Data
Mar. 13, 2015 (JP) 2015-050201

(51) Int. Cl. B32B 43/00; B32B 38/10; B41J 3/407

(52) U.S. Cl. CPC B32B 43/006; B41J 3/4075; B32B 38/10

(57) ABSTRACT

A label medium carrying device includes a medium carrying part that carries a separation label medium configured with a label member having an adhesive face and a peeling member superimposed on the adhesive face, a trailing edge peeling part that peels the trailing edge portion of the peeling member off the adhesive face in a trailing edge side of the separation label medium, and a folding trace forming part that forms a folding trace on the trailing edge portion of either the peeling member or the label member that is peeled off by the trailing edge peeling part.

### CROSS REFERENCE

The present application is related to, claims priority from and incorporates by reference Japanese Patent Application No. 2015-050201, filed on Mar. 13, 2015.

### TECHNICAL FIELD

This invention relates to a label medium carrying device that carries a label medium, a label medium carrying method, and a print device comprising the label medium carrying device.

### BACKGROUND

Popularly used are print devices that print images on a label medium in a tape-shape (tape-shape medium) comprising a print label (label member) having an adhesive face and a backing sheet (peeling member) superimposed on the adhesive face. A user folds with his hands a longitudinal-direction end of a separation label medium that has images printed and is separated (cut) to make a state where the backing sheet can easily be peeled off the print label, grabs and peels off the backing sheet with his fingers to expose the adhesive face of the print label, and paste the adhesive face of the print label to a desired member.

In general, an unused label medium is offered in the state of a roll wound around a cylindrical shaft. In order to increase the length of a print label contained in one roll, the backing sheet thickness should desirably be reduced. However, if the backing sheet becomes thin, the work of peeling the backing sheet off becomes even more difficult.

As a measure against such a problem, the method of Patent Document 1 is proposed. In this method, the user peels a peeling tape (peeling member) off a recording tape (label member) in a tape cartridge of a print tape (label medium having the peeling tape adhered to the recording tape) in advance, and afterwards attaches the tape cartridge to the tape print device. The tape print device re-adheres the peeling tape to the recording tape in the process of carrying the print tape inside the tape cartridge. Because the adhesive force between the re-adhered recording tape and peeling tape is relatively weak, the user can peel the peeling tape off relatively easily.

### PRIOR ART DOCUMENTS

### [Patent Document 1] Japanese Unexamined Patent Application 2005-239384

However, in the method of Patent Document 1, the user needs to perform a work of peeling the peeling tape (peeling member) off the recording tape (label member) in the tape cartridge. If the user peels the peeling tape off the recording tape using his nail or a sharp tool, the recording tape may be scratched. Also, such work requires time and labor to the user.

The objective of this invention is to offer a label medium carrying device, a print device, and a label medium carrying method that provide the user with a separation label medium that reduces the work required to the user and facilitates peeling the peeling member off the label member.

### SUMMARY

A label medium carrying device is disclosed in the application. The device includes a medium carrying part that carries a separation label medium configured with a label member having an adhesive face and a peeling member superimposed on the adhesive face, a trailing edge peeling part that peels the trailing edge portion of the peeling member off the adhesive face in a trailing edge side of the separation label medium, and a folding trace forming part that forms a folding trace on the trailing edge portion of either the peeling member or the label member that is peeled off by the trailing edge peeling part.

A label medium carrying method executed by a label medium carrying device is disclosed in the application. The method includes a carrying step that carries a separation label medium, which is configured with a label member having an adhesive face and a peeling member superimposed on the adhesive face, from an upstream to a downstream of a medium carrying path, a peeling step that peels a trailing edge portion of the peeling member off the adhesive face of the label member from a trailing edge portion of the separation label medium, and a folding trace forming step that forms a folding trace on the trailing edge portion of either the peeling member or the label member that is peeled off in the peeling step.

According to this invention, a trailing edge peeling part peels the trailing edge portion of the peeling member off the adhesive face of the label member in the trailing edge side of the separation label medium, and a folding trace forming part forms a folding trace on the trailing edge portion of the peeled-off peeling member. When the peeling member and the adhesive face of the label member are re-adhered, the face including the folding trace formed on the peeling member is re-adhered to the adhesive face of the label member. Because the peeling member is not flat any longer due to the folding trace, the adhesive force between the adhesive face of the label member and the peeling member becomes weak. Therefore, the user can easily peel the peeling member off the label member of the separation label medium.

### BRIEF DESCRIPTION OF DRAWINGS

FIG. 1 is a schematic cross-sectional view showing a label medium carrying device and a print device of an embodiment of this invention.

FIG. 2 is a schematic cross-sectional view showing the configuration of a cutter unit as a medium separation part of the label medium carrying device shown in FIG. 1.

FIG. 3 is a schematic cross-sectional view showing the configuration of a trailing edge peeling part and a folding trace forming part of the label medium carrying device shown in FIG. 1.

FIGS. 4A and 4B are a schematic cross-sectional view and a schematic plan view showing the operation (when starting a peeling process) of the label medium carrying device of the embodiment.

FIGS. 5A and 5B are a schematic cross-sectional view and a schematic plan view showing the operation (in the middle of the peeling process) of the label medium carrying device of the embodiment.

FIGS. 6A and 6B are a schematic cross-sectional view and a schematic plan view showing the operation (when finishing the peeling process) of the label medium carrying device of the embodiment.

FIGS. 7A and 7B are a schematic cross-sectional view and a schematic plan view showing the operation (folding trace forming process) of the label medium carrying device of the embodiment.

FIGS. 8A and 8B are a schematic cross-sectional view and a schematic plan view showing the operation (when starting an ejection process) of the label medium carrying device of the embodiment.

FIGS. 9A and 9B are a schematic cross-sectional view and an enlarged cross-sectional view showing the operation (ejection process) of the label medium carrying device of the embodiment.

FIG. 10 is a block diagram showing the schematic configuration of the control system of the label medium carrying device shown in FIG. 1.

FIG. 11 is a flow chart showing the operation of the label medium carrying device and the print device shown in FIG. 1.

FIG. 12 is a flow chart showing the print process and the carrying process shown in FIG. 11.

FIG. 13 is a flow chart showing the separation (cutting) process shown in FIG. 11.

FIG. 14 is a flow chart showing the peeling process shown in FIG. 11.

FIG. 15 is a flow chart showing the folding trace forming process shown in FIG. 11.

FIG. 16 is a flow chart showing the ejection process shown in FIG. 11.

### DETAILED EMBODIMENTS

### 1. Outline of the Embodiment

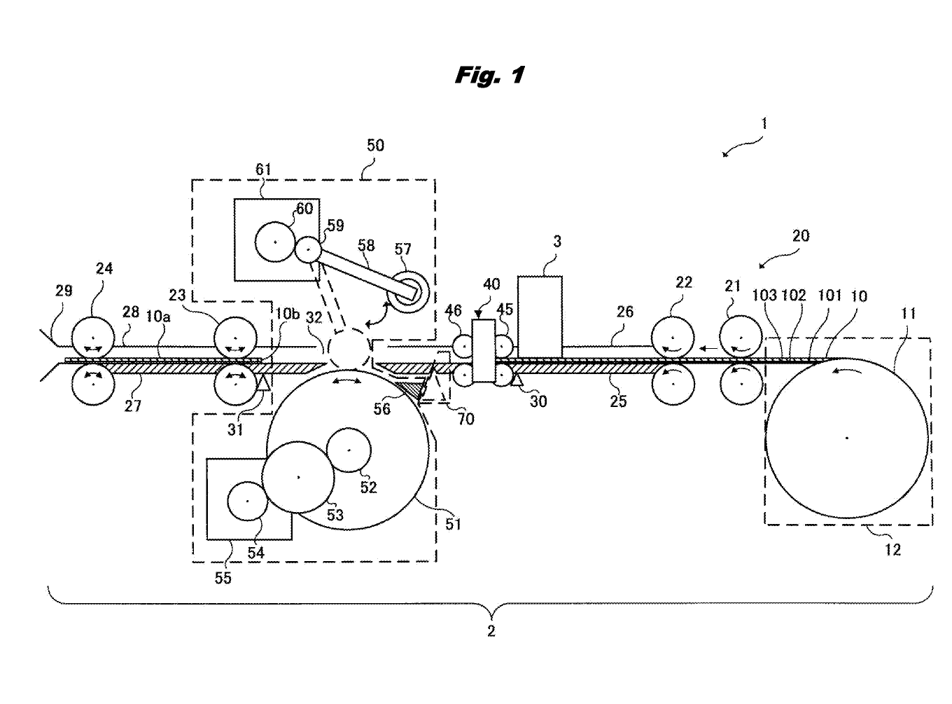

FIG. 1 is a schematic cross-sectional view showing a label medium carrying device 2 and a print device 1 of an embodiment of this invention. As shown in FIG. 1, the print device 1 is provided with the label medium carrying device 2 that carries a label medium 10, and a print part 3 that prints images on the label medium 10.

The label medium 10 is a tape-shape medium that comprises a print label (the upper layer of the label medium 10 in FIG. 1) 101 as the label member, on which images are printed, and a backing sheet (the lower layer of the label medium 10 in FIG. 1) 102 as the peeling member (peeling sheet) superimposed on it. The print label 101 comprises an adhesive face 103 formed of an adhesive layer and the like. The backing sheet 102 is superimposed on the adhesive face 103 of the print label 101. In general, a face of the backing sheet 102 contacting with the adhesive face 103 is provided with a peeling face to facilitate peeling the backing sheet 102 off the adhesive face 103. The peeling face is, for example, a face with a silicon processing applied. The label medium 10 is, for example, pulled out from a tray part 12 that rotatably stores a label roll 11 wherein the long tape-shape label medium 10 is wound in a roll shape. Note that the label medium 10, to which this invention is applicable, is not limited to a medium offered as the label roll 11 in a roll shape shown in FIG. 1. The label medium 10, to which this invention is applicable, can also be a label medium in another shape if it comprises a print label 101 as the label member having an adhesive face 103, and a backing sheet 102 as the peeling member superimposed on this adhesive face 103. For example, the label medium 10, to which this invention is applicable, can also be a sheet-shape medium (leaf paper) precut to a specified length.

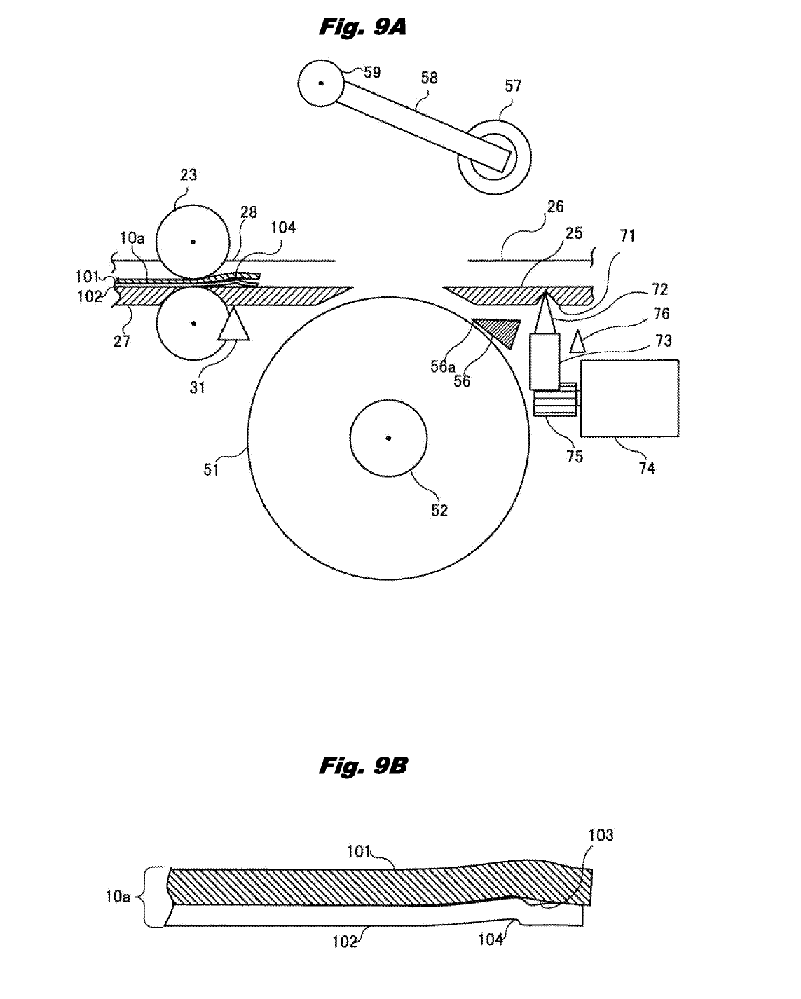

The label medium carrying device 2 performs a carrying process of the label medium 10, a separation (cutting) process of the label medium 10, a peeling process to peel the backing sheet 102 off the print label 101, a folding trace forming process to form a folding trace on the backing sheet 102, and an ejection process to carry the label medium 10 with the folding trace formed to the outside of the device. The label medium carrying device 2 of this embodiment is characterized in that the trailing edge portion of the backing sheet 102 is peeled off the adhesive face 103 (peeling process) in the trailing edge side (label roll 11 side) of the separation label medium 10a that is the label medium 10 after the separation process, and that on this peeled-off trailing edge portion (that is, trailing edge vicinity portion) a folding trace (a protruding portion in FIGS. 9A and 9B mentioned below) 104 is formed (folding trace forming process). Although the trailing edge portion of the backing sheet 102 and the adhesive face 103 of the print label 101 of the separation label medium 10a ejected to the outside of the label medium carrying device 2 are re-adhered in the middle of the ejection process, because the backing sheet 102 is not flat (has ups and downs) due to the folding trace 104, the adhesive force between the adhesive face 103 of the print label 101 and the backing sheet 102 becomes weak. Therefore, the user can easily peel with his hands the backing sheet 102 off the print label 101 of the ejected separation label medium 10a.

### 2. Configuration of the Embodiment

### 2-1. Print Part 3

The print part 3 prints images such as characters, codes, and figures on the print label 101. As the print system of the print part 3, for example, a thermal transfer system where ink is thermally transferred from an ink ribbon to the surface of the print label 101 (upper face of the print label 101 in FIG. 1), or a thermal system where the print label 101 is a thermal tape can be adopted. In this case, the print part 3 is provided with a thermal head wherein multiple micro-heating elements are disposed in alignment, and the micro-heating elements are selectively allowed to radiate heat by electrification corresponding to the image data. Also, as the print system adopted by the print part 3, another system such as an inkjet system or an electrophotographic system can be adopted. In this manner, the print system of the print device 1, to which this invention is applied, is not limited to a specific system. Also, if printing is unnecessary in such cases as when the label medium 10 itself is colored or patterned, it can be operated so that the label medium is cut and ejected without performing printing. Therefore, the device shown in FIG. 1 can be offered as the label medium carrying device 2 that is not provided with the print part 3.

### 2-2. Label Medium Carrying Device 2

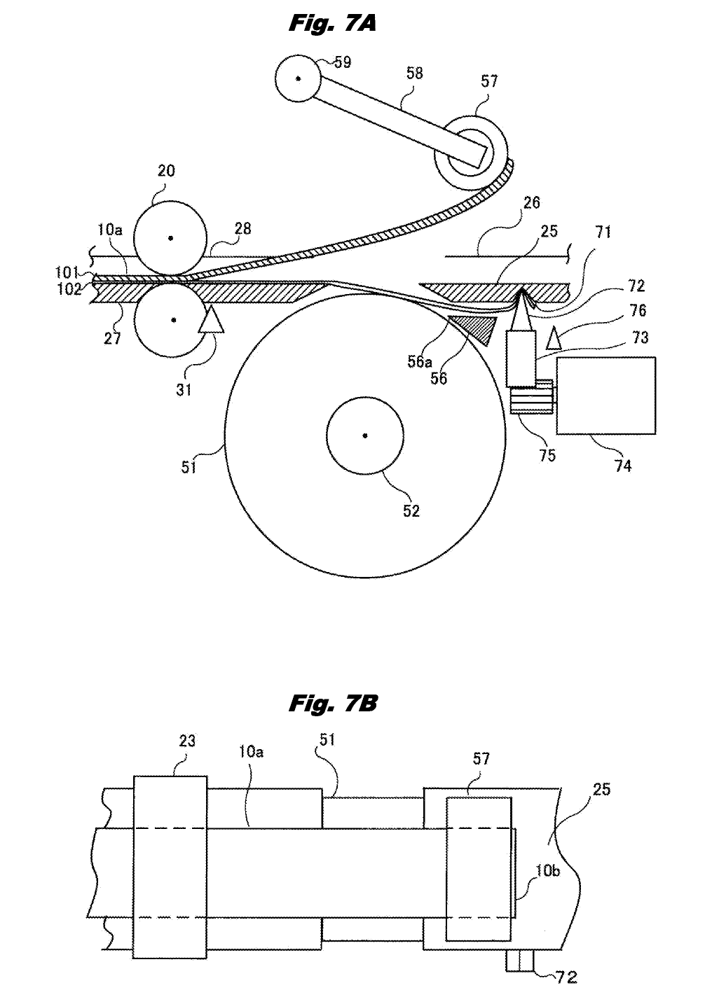

As shown in FIG. 1, the label medium carrying device 2 is provided with a medium carrying part 20 that carries the label medium 10, a cutter unit 40 as the medium separation part that separates the separation label medium 10a that is a part of the leading edge side of the label medium 10 carried by the medium carrying part 20, a trailing edge peeling part 50 that peels the trailing edge portion of the backing sheet 102 off the adhesive face 103 in the trailing edge 10b side of the separation label medium 10a, and a folding trace forming part (tracing part) 70 that forms a folding trace 104 (shown in FIG. 7A mentioned below) on the trailing edge portion of the backing sheet 102 peeled off by the trailing edge peeling part 50. Besides, if the label medium 10 is a precut sheet-shape medium, there is no need to provide the cutter unit 40.

Medium Carrying Part 20

As shown in FIG. 1, the medium carrying part 20 is provided with the tray part 12 that rotatably stores the label roll 11, carrying roller pairs 21 and 22 of the label roll 11 side (upstream side) that carry the label medium 10, and carrying roller pairs 23 and 24 of the carry-out port 29 side (downstream side) that carry the separation label medium 10a. Also, the medium carrying part 20 is provided with a lower guide member 25 and an upper guide member 26 as guide members that guide the label medium 10 before the cutting process, and a lower guide member 27 and an upper guide member 28 as guide members that guide the separation label medium 10a after the cutting process. The lower guide member 25 and the upper guide member 26 form a carrying path that guides the label medium 10, and the lower guide member 27 and the upper guide member 28 form a carrying path that guides the separation label medium 10a. The carrying path formed by the lower guide member 25 and the upper guide member 26 and the carrying path formed by the lower guide member 27 and the upper guide member 28 are separated, and the space between these carrying paths is also called an opening part 32. It is also possible to adopt a configuration where Teflon (a registered trademark) coating, fluorine treatment, and the like are applied on the inner faces of the lower guide members 25 and 27 and the inner faces of the upper guide members 26 and 28. It is for preventing the print label 101 and the carrying paths from being attracted by the adhesive face 103 if the print label 101 peels off the second adhesive roller 57 and the adhesive layer contacts with the carrying path.

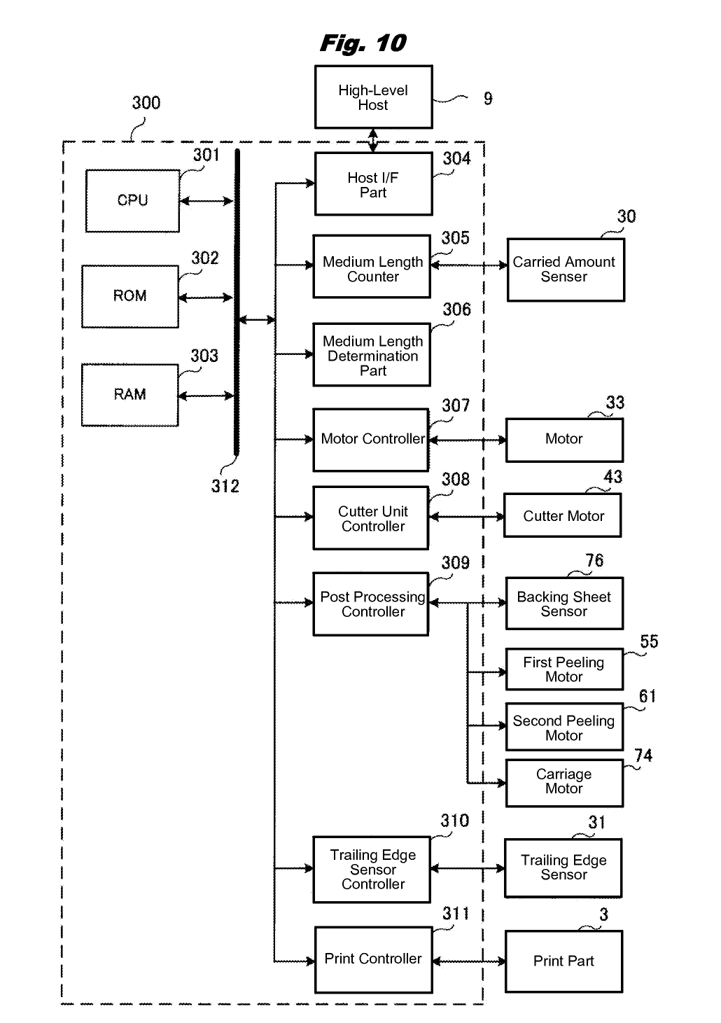

Also, the medium carrying part 20 is provided with a carried amount sensor 30 that detects the label medium 10 before the cutting process, and a trailing edge sensor 31 that detects the trailing edge of the separation label medium 10a. For the carried amount sensor 30 and the trailing edge sensor 31, any detection system such as a mechanical sensor and an optical sensor can be adopted. One of the multiple carrying rollers constituting the carrying roller pairs 21 and 22 rotates by receiving a drive force from a motor (for example, a motor 33 in FIG. 10 mentioned below) and the like as a drive force generating source, and carries the label medium 10 from the upstream side toward the downstream side. Also, one of the multiple carrying rollers constituting the carrying roller pairs 23 and 24 rotates by receiving a drive force from a drive part such as a motor (for example, a motor 33 in FIG. 10 mentioned below) and the like, and carries the separation label medium 10a from the upstream side toward the downstream side or from the downstream side toward the upstream side. The number of the carrying roller pairs 21, 22, 23, and 24 is not limited to the example in FIG. 1. Also, the structure of the carrying roller pairs 21, 22, 23, and 24 is not limited to the example in FIG. 1, and any carrying rollers or carrying belts that form a pair may be adopted.

The carried amount sensor 30 detects the carried amount of the label medium 10, that is, the longitudinal-direction length of the separation label medium 10a after the cutting process. The cutter unit 40 cuts the carried label medium 10 and separates the separation label medium 10a that is a part of the leading edge side of the label medium 10 from the label medium 10 wound around the label roll 11. The trailing edge sensor 31 detects the trailing edge 10b of the carried separation label medium 10a. The carrying roller pairs 23 and 24 carry the separation label medium 10a in the longitudinal direction (carrying direction) of the separation label medium 10a. Carrying the separation label medium 10a is guided by a carrying path constituted of the lower guide member 27 and the upper guide member 28. In the downstream side where the separation label medium 10a is ejected, a carry-out port 29 is disposed. The separation label medium 10a is ejected through the carry-out port 29. The carrying roller pairs 23 and 24 are driven by a drive force generated by a drive force generating source such as a motor. Besides, the carrying roller pairs 21, 22, 23, and 24, the lower guide members 25 and 27, the upper guide members 26 and 28, the carried amount sensor 30, and the trailing edge sensor 31 constitute the medium carrying part 20.

Cutter Unit 40

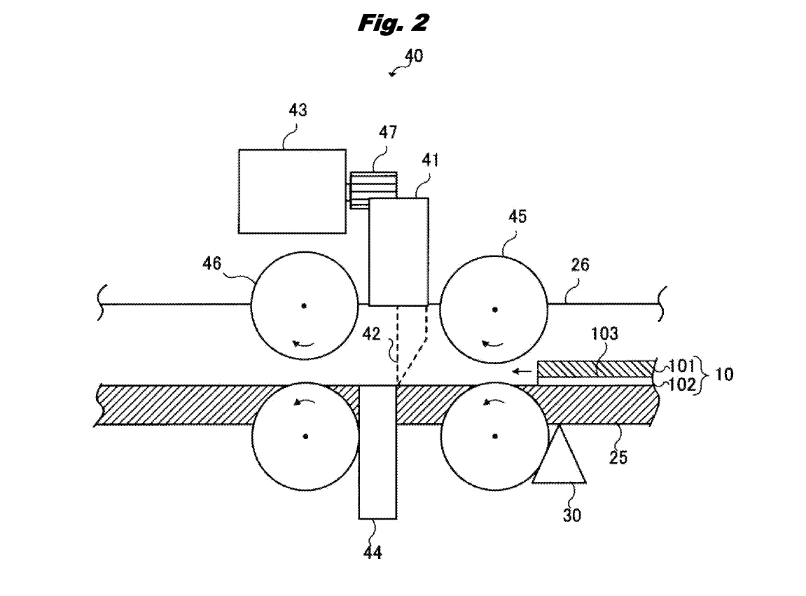

FIG. 2 is a schematic cross-sectional view showing the configuration of the cutter unit 40 as the medium separation part of the label medium carrying device 2. As shown in FIG. 2, the cutter unit 40 is provided with a cutter carriage 41, an upper blade 42, a cutter motor 43 as the drive force generating source, and a lower blade 44. Also, the cutter unit 40 may be provided with cutter roller pairs 45 and 46 that carry the label medium 10. The cutter carriage 41 is provided with the upper blade 42. The upper blade 42 moves by the cutter carriage 41 toward the lower blade 44, sandwiches the label medium 10 in the space with the lower blade 44, and cuts the label medium 10. The cutter roller pairs 45 and 46 are disposed on both sides of the cutter carriage 41 that is between them in the carrying direction of the label medium 10. The drive force generated by the cutter motor 43 is transmitted to the upper blade 42 through the cutter carriage 41, and moves the upper blade 42 in a direction perpendicular to the carrying direction. Thereby, the label medium 10 is cut. Note that the structure of the cutter unit 40 is not limited to the example in FIG. 2, and as far as it is a structure that allows cutting the label medium 10, it is not particularly limited.

Trailing Edge Peeling Part 50

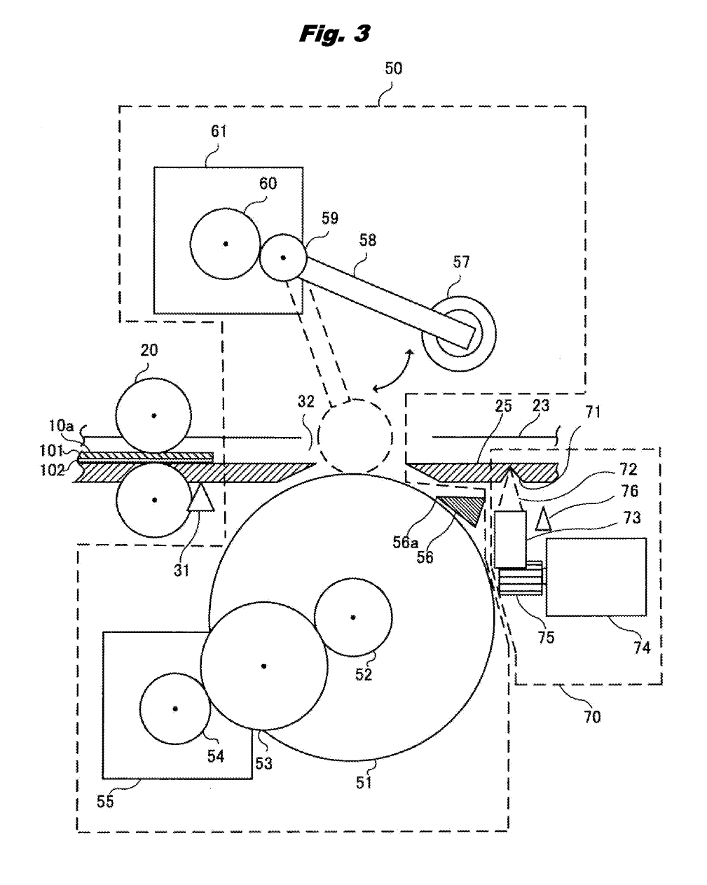

FIG. 3 is a schematic cross-sectional view showing the configuration of the trailing edge peeling part 50 and the folding trace forming part 70 of the label medium carrying device 2. The trailing edge peeling part 50 comprises a first adhesive roller (lower adhesive roller) 51 in contact with the backing sheet 102 of the separation label medium 10a, a first drive mechanism that rotates the first adhesive roller 51, a second adhesive roller (upper adhesive roller) 57 in contact with the print label 101 of the separation label medium 10a, and a second drive mechanism that moves the second adhesive roller 57 in a direction away from the first adhesive roller 51.

The first adhesive roller 51 and the first drive mechanism of the trailing edge peeling part 50 constitute a first attracting part that attracts the backing sheet 102 of the separation label medium 10a. The first drive mechanism of the trailing edge peeling part 50 is provided with a gear 52 fixed to the rotational center shaft of the first adhesive roller 51, a gear 53 engaging with the gear 52, a gear 54 engaging with the gear 53, a first peeling motor 55 as the drive force generating source that rotates the gear 54, and a guide member 56. The first adhesive roller 51 adheres to the backing sheet 102 of the label medium 10, rotates, and guides the backing sheet 102 of the label medium 10 to the folding trace forming part 70. The strength of the adhesive force of the surface of the first adhesive roller 51 is sufficient for carrying the backing sheet 102 to the folding trace forming part 70. Note that this adhesive force should be given an appropriate strength so that the backing sheet 102 peels off the first adhesive roller 51 when the edge portion of the backing sheet 102 contacts with the tip part 56a of the guide member 56. When the first peeling motor 55 is driven, the rotational drive force is transmitted to the shaft of the first adhesive roller 51 through the drive force transmission mechanism comprising the gears 54, 53, and 52, and rotates the first adhesive roller 51 in a desired direction.

The second adhesive roller 57 and the second drive mechanism of the trailing edge peeling part 50 constitute a second attracting part that attracts the backing sheet 102 of the separation label medium 10a. The second drive mechanism of the trailing edge peeling part 50 is provided with the second adhesive roller 57, a roller bar 58 as a supporting member that supports the second adhesive roller 57, a gear 59 provided coaxially to the rotational center shaft of the roller bar 58, a gear 60 engaging with the gear 59, and a second peeling motor 61 as the drive force generating source that rotates the gear 60. The second adhesive roller 57 has a sufficient adhesive force for adhering to and lifting the print label 101 of the label medium 10. When the second peeling motor 61 is driven, the rotational drive force is transmitted to the second adhesive roller 57 through the drive force transmission mechanism comprising the gears 60 and 59 and the roller bar 58, and moves the second adhesive roller 57 closer to or away from the first adhesive roller 51 (the opening part 32).

Besides, the structure of the first attracting part including the first adhesive roller 51 and the structure of the second attracting part including the second adhesive roller 57 are not limited to those shown in FIG. 3. For example, instead of the first adhesive roller 51 and the second adhesive roller 57, another configuration such as a structure wherein the separation label medium 10a is sucked by an airflow may be adopted.

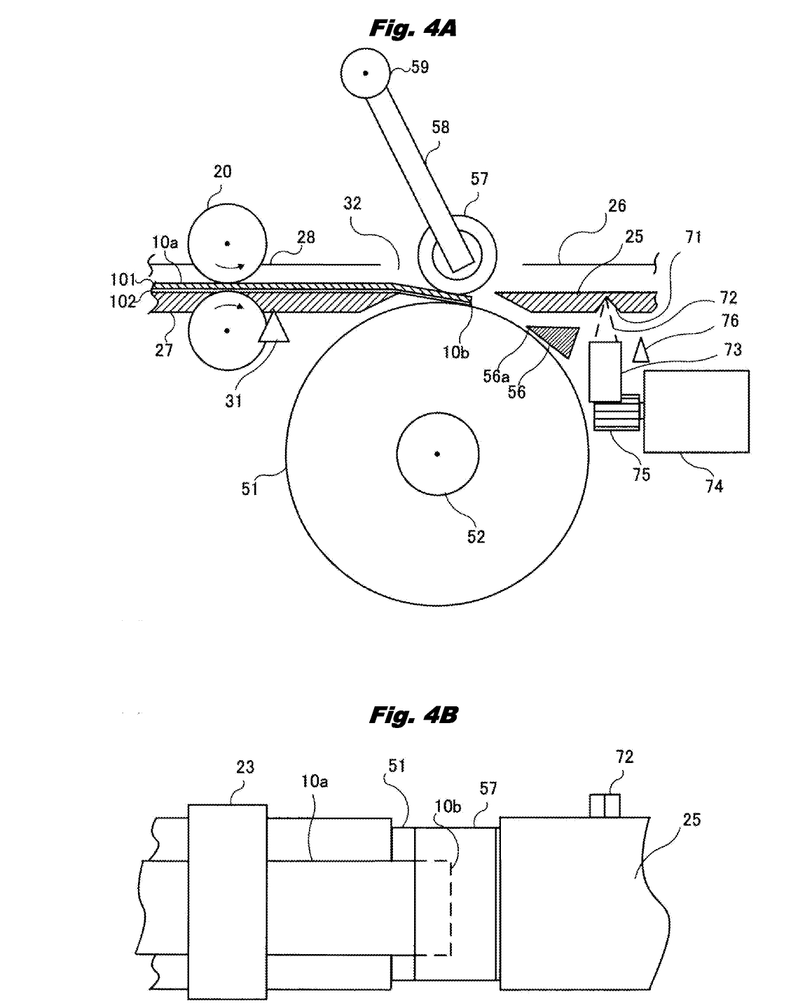

FIGS. 4A and 4B are a schematic cross-sectional view and a schematic plan view showing the operation (when starting the peeling process) of the label medium carrying device 2. As shown in FIGS. 4A and 4B, the peeling process is started by the carrying roller pair 23 carrying the separation label medium 10a with the trailing edge 10b first toward the upstream side. In the vicinity of the trailing edge 10b portion of the separation label medium 10a, the second adhesive roller 57 adheres to the upper face of the print label 101, and the first adhesive roller 51 adheres to the lower face of the backing sheet 102.

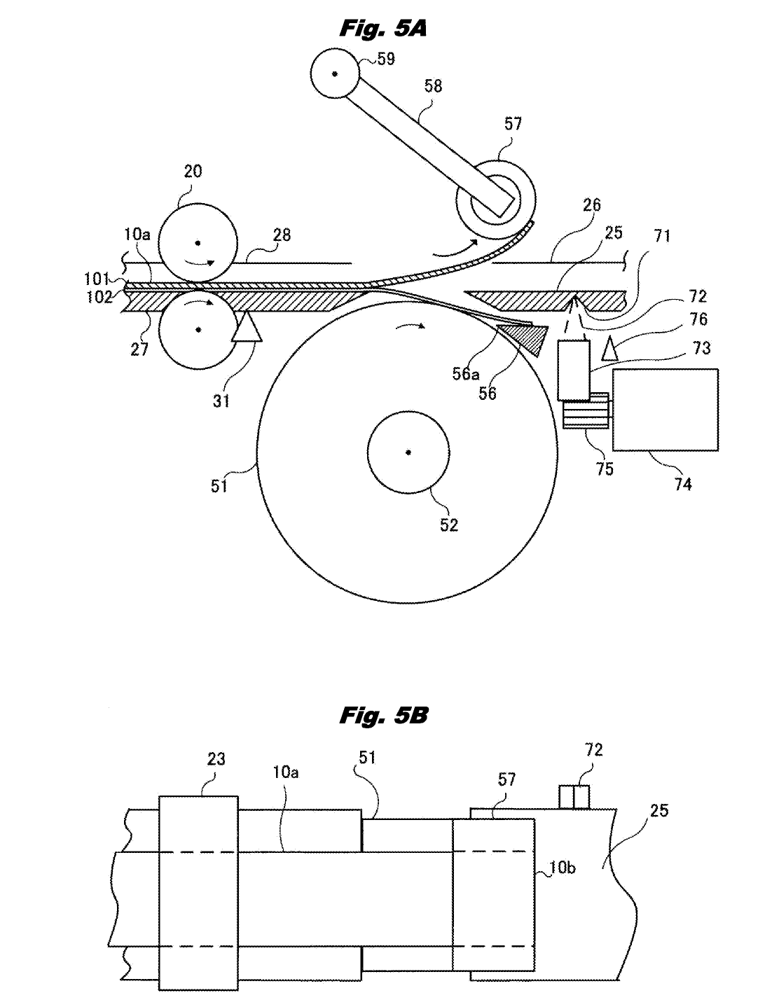

FIGS. 5A and 5B are a schematic cross-sectional view and a schematic plan view showing the operation (in the middle of the peeling process) of the label medium carrying device 2. As shown in FIGS. 5A and 5B, the second adhesive roller 57 moves away from the opening part 32, and the first adhesive roller 51 rotates in the clockwise direction in the figure. Therefore, a force is applied to the print label 101 of the separation label medium 10a in the direction of pulling away the backing sheet 102, and a force is applied to the backing sheet 102 of the separation label medium 10a in the direction of pulling it away from the print label 101. Therefore, as shown in FIG. 5A, the trailing edge portion of the backing sheet 102 is peeled off the print label 101 and guided to the lower side of the carrying path by the rotation of the first adhesive roller 51. Then, the trailing edge portion of the backing sheet 102 is separated from the first adhesive roller 51 by the tip part 56a of the guide member 56, and guided to the folding trace forming part 70.

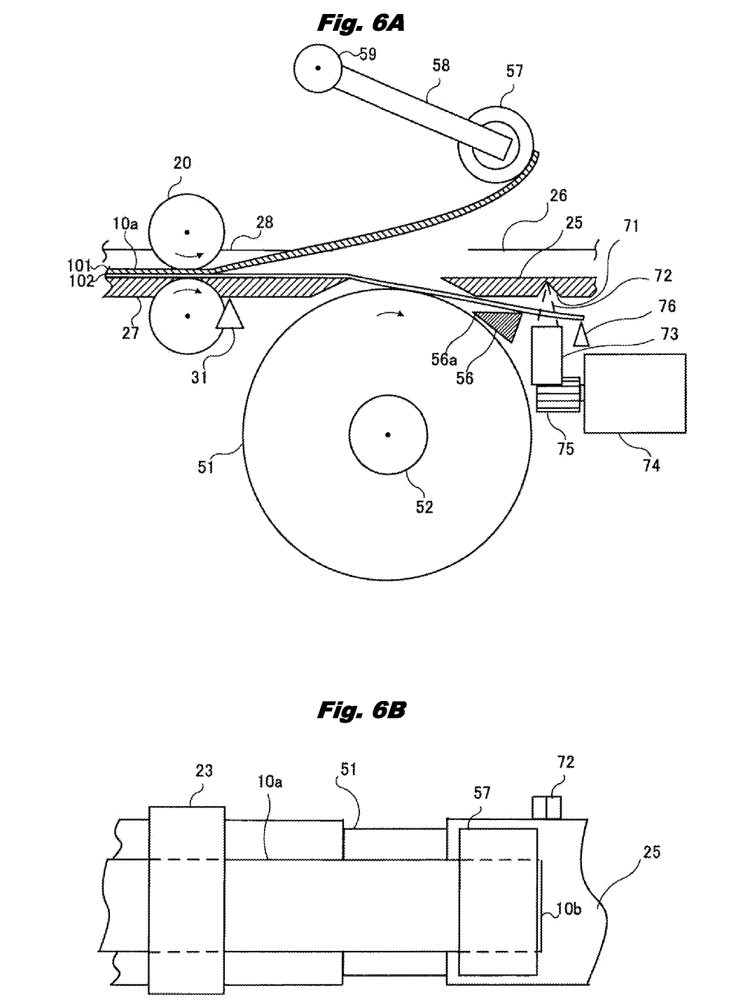

FIGS. 6A and 6B are a schematic cross-sectional view and a schematic plan view showing the operation (when finishing the peeling process) of the label medium carrying device 2. As shown in FIGS. 6A and 6B, the trailing edge portion of the backing sheet 102 reaches the position of a backing sheet sensor 76 of the folding trace forming part 70. By the backing sheet sensor 76 detecting the trailing edge, the rotation of the carrying roller pair 23, the movement of the second adhesive roller 57, and the rotation of the first adhesive roller 51 stop.

Folding Trace Forming Part 70

As shown in FIG. 3, the folding trace forming part 70 is disposed in the upstream side of the first adhesive roller 51 and the second adhesive roller 57 of the trailing edge peeling part 50. The folding trace forming part 70 forms a folding trace 104 on the trailing edge portion of the backing sheet 102 peeled off the separation label medium 10a. The folding trace forming part 70 is provided with a folding trace forming groove 71 as a concave part opposing the trailing edge portion of the backing sheet 102 peeled off by the trailing edge peeling part 50, and a pressing member 72 as a convex part that opposes the folding trace forming groove 71 and presses the trailing edge portion of the backing sheet 102 into the folding trace forming groove 71. Also, the folding trace forming part 70 is provided with a folding trace forming carriage part 73, a carriage motor 74 as the drive force generating source, and a gear 75 as a power transmission mechanism that transmits the drive force of the carriage motor 74 to the folding trace forming carriage part 73. The folding trace forming groove 71 is, for example, a long groove formed on the opposite side (lower face in the figure) of the face that guides the label medium 10 of the lower guide member 25 constituting the carrying path. By the trailing edge portion of the backing sheet 102 being pressed between the pressing member 72 of the folding trace forming carriage part 73 and the folding trace forming groove 71, the folding trace 104 is formed on the backing sheet 102. At this time, the folding trace forming carriage part 73 moves (scans) in the direction parallel to the side of the trailing edge of the label medium 10 by the drive force of the carriage motor 74 while pressing the backing sheet 102 into the folding trace forming groove 71.

FIGS. 7A and 7B are a schematic cross-sectional view and a schematic plan view showing the operation (folding trace forming process) of the label medium carrying device 2. As shown in FIGS. 7A and 7B, the folding trace forming carriage part 73 moves in the direction parallel to the side of the trailing edge of the label medium 10 while pressing the backing sheet 102 into the folding trace forming groove 71. By the backing sheet 102 being sandwiched between the folding trace forming carriage part 73 and the folding trace forming groove 71, the folding trace 104 is formed on the trailing edge portion of the backing sheet 102.

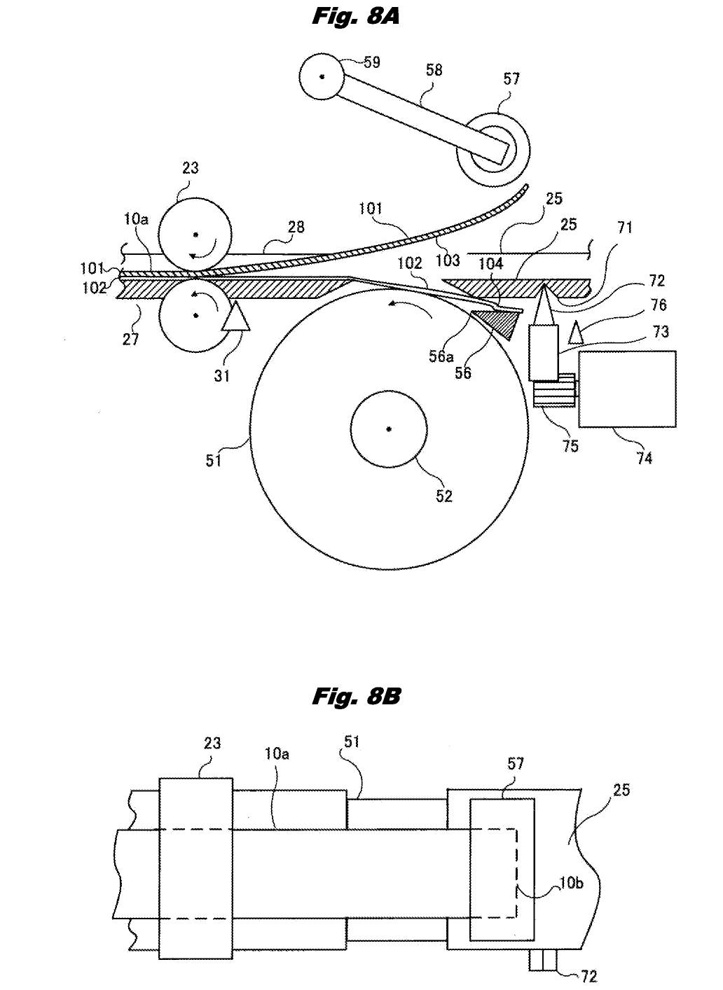

FIGS. 8A and 8B are a schematic cross-sectional view and a schematic plan view showing the operation (when starting the ejection process) of the label medium carrying device 2. By the carrying roller pair 23 and the first adhesive roller 51 rotating, a force toward the downstream side is applied to the separation label medium 10a. Due to this force, the print label 101 is peeled off the second adhesive roller 57, and the backing sheet 102 is peeled off the first adhesive roller 51. The print label 101 and the backing sheet 102 of the separation label medium 10a are carried toward the downstream side (the carry-out port 29).

FIGS. 9A and 9B are a schematic cross-sectional view and an enlarged cross-sectional view showing the operation (ejection process) of the label medium carrying device 2. FIG. 9A shows the middle of a process wherein the separation label medium 10a is ejected by the carrying roller pairs 23 and 24. FIG. 9B is a figure explaining the trailing edge 10b of the separation label medium 10a after the separation label medium 10a passed through the carrying roller pairs 23 and 24. The print label 101 and the backing sheet 102 are sandwiched by the carrying roller pairs 23 and 24. However, the folding trace 104 formed on the trailing edge portion of the backing sheet 102 does not disappear due to the sandwiching by the carrying roller pairs 23 and 24. The folding trace 104 remains on the backing sheet 102 even after passing through the carrying rollers 23 and 24. By the folding trace 104, the adhesive force of the backing sheet 102 to the adhesive face 103 of the print label 101 can be weakened. Therefore, the trailing edge side of the separation label medium 10a comes into a state that the print label 101 and the backing sheet 102 are separated, or a state that the adhesive force working between the print label 101 and the backing sheet 102 is weak enough to peel off easily.

Control Circuit 300

FIG. 10 is a block diagram showing a schematic configuration of a control circuit 300 that is the control system of the label medium carrying device 2. The control circuit 300 is provided with a CPU (Central Processing Unit) 301, ROM (Read Only Memory) 302 as a memory part, and RAM (Random Access Memory) 303 as a memory part. The CPU 301 has below-mentioned multiple controllers included in the circuit execute processes while sequentially reading out programs stored in the ROM 302 through a data bus 312. Also, the CPU 301 uses the RAM 303 as necessary for storing print data such as images to print on the print label 101 and medium (label medium) length data including the length in the carrying direction of the label medium 10 to be cut received from an higher-level host 9 such as a computer connected to the print device 1 comprising the label medium carrying device 2.

Furthermore, the control circuit 300 is provided with a host I/F (interface) part 304, a medium length counter 305, a medium length determination part 306, a motor controller 307, a cutter unit controller 308, a postprocessing controller 309, a trailing edge sensor controller 310, and a print controller 311. Processes by the multiple controllers explained below are performed through the control by the CPU 301.

The host I/F part 304 receives print data, medium length data, etc. sent from the higher-level host 9. Also, the host I/F part 304 sends to the higher-level host 9 a notification signal for notifying errors etc. that occurred in the print device 1.

The medium length counter 305 counts, as a medium length counter value, the carried amount of the label medium 10 detected by the carried amount sensor 30, and outputs the counted medium length counter value. The medium length counter value is input to the medium length determination part 306.

The medium length determination part 306 determines the length of the carried label medium 10 based on the mechanical sizes of the cutter unit 40 and the carried amount sensor 30 and the medium length counter value output from the medium length counter 305. If the medium length determination part 306 has determined that the length of the carried label medium 10 coincides with the length based on the medium length data received by the host I/F part 304, it demands the below-mentioned motor controller 307 to stop the carrying roller pairs 23 and 24. Based on the demand of the medium length determination part 306, the motor controller 307 stops the carrying roller pairs 23 and 24.

The motor controller 307 controls the rotations of the carrying roller pairs 21, 22, 23, and 24 by driving the drive force generating source such as a motor. Besides, although one motor controller 307 controls all the carrying roller pairs in the embodiment, a configuration wherein the motors have separate motor controllers is also possible.

The cutter unit controller 308 controls the operation in the cutter unit 40. The cutter unit controller 308 drives the cutter motor 43 to move the cutter carriage 41 and have the upper blade 42 scan in a direction that is perpendicular to the carrying direction of the label medium 10 and along the lower guide member 25 constituting the carrying path. Also, once it is detected by a sensor etc. that the upper blade 42 has reached the end of the scan direction, the cutter unit controller 308 stops the cutter motor 43.

The postprocessing controller 309 controls the operations of the trailing edge peeling part 50 and the folding trace forming part 70. When the separation label medium 10a is carried to the upstream side, the postprocessing controller 309 drives the second peeling motor 61 to move the second adhesive roller 57 toward the opening part 32, and drives the first peeling motor 55 to rotate the first adhesive roller 51. Also, when the backing sheet 102 is detected by the backing sheet sensor 76, the postprocessing controller 309 stops the second peeling motor 61 to stop the movement of the second adhesive roller 57, and stops the first peeling motor 55 to stop the rotation of the first adhesive roller 51. The postprocessing controller 309 drives the carriage motor 74 to have the folding trace forming carriage part 73 scan. The backing sheet 102 is pressed between the folding trace forming carriage part 73 and the folding trace forming groove 71 to form the folding trace 104. Besides, once it is detected by a sensor that the folding trace forming carriage part 73 has moved to the end of the folding trace forming part 70, the postprocessing controller 309 stops the carriage motor 74.

If the trailing edge side of the separation label medium 10a is detected by the trailing edge sensor 31, the trailing edge sensor controller 310 demands the motor controller 307 to stop the rotations of the carrying roller pairs 23 and 24. Based on the demand by the trailing edge sensor controller 310, the motor controller 307 stops driving the drive force generating source such as a motor to stop the rotations of the carrying roller pairs 23 and 24.

The print controller 311 controls the print part 3 so as to print on the label medium 10 based on the print data.

### 3. Operations of the Embodiment

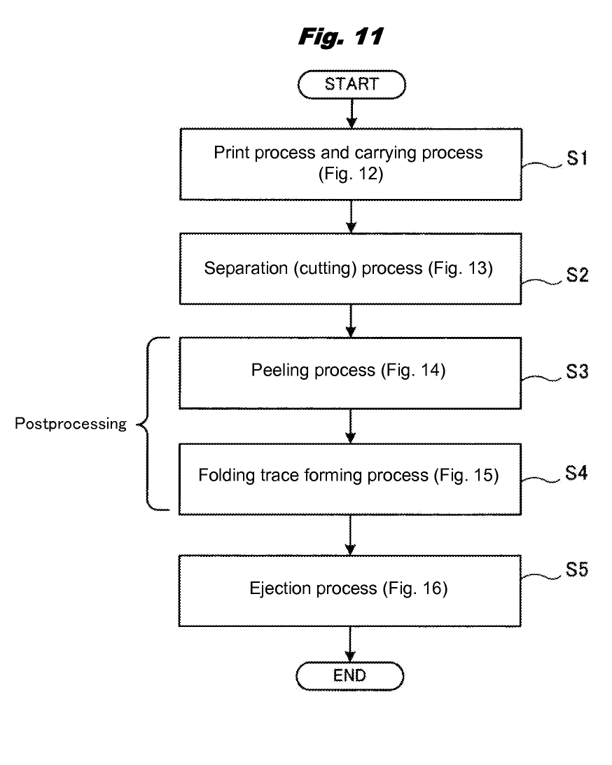

FIG. 11 is a flow chart showing the operations of the label medium carrying device 2 and the print device 1 of this embodiment. The print device 1 performs the carrying process and the print process (S1), the separation (cutting) process (S2), the peeling process (FIGS. 4A, 4B, 5A, 5B, 6A, and 6B, and Step S3), the folding trace forming process (FIGS. 7A and 7B, and Step S4), and the ejection process (FIGS. 8A, 8B, 9A, and 9B, and Step S5). Because the peeling process (S3) and the folding trace forming process (S4) are performed after the print process, they are also called the postprocessing.

Also, the label medium carrying device 2 performs the cutting process (S2), the peeling process (FIGS. 4A, 4B, 5A, 5B, 6A, and 6B, and Step S3), the folding trace forming process (FIGS. 7A and 7B, and Step S4), and the ejection process (FIGS. 8A, 8B, 9A, and 9B, and Step S5). Also, processes of S2 through S5 correspond to the individual steps of the label medium carrying method of this embodiment.

Print Process and Carrying Process

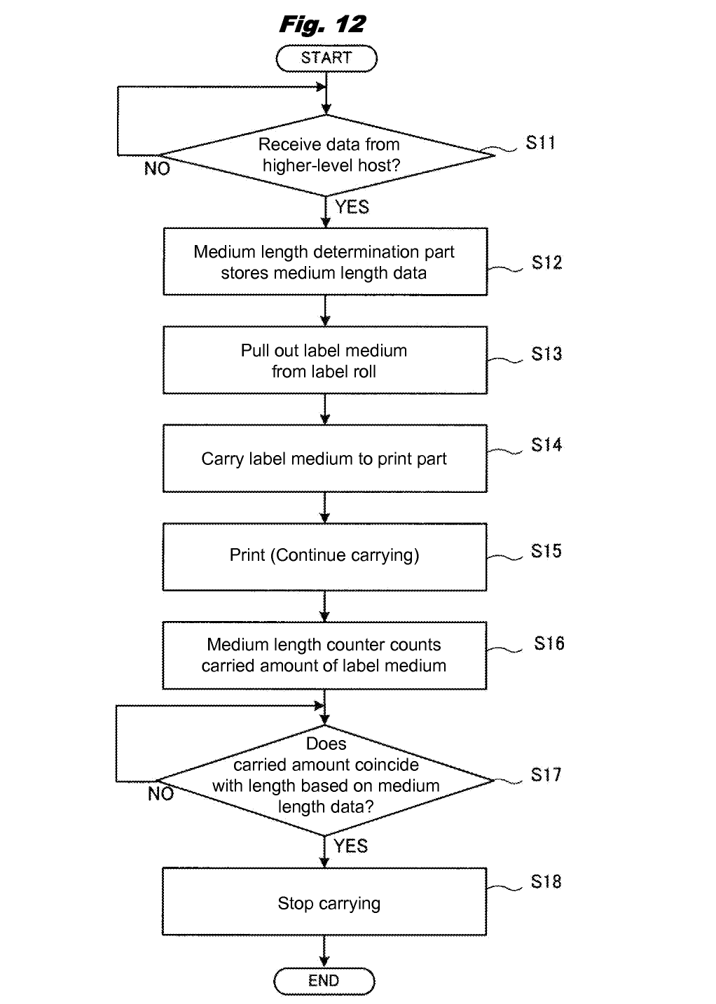

FIG. 12 is a flow chart showing the print process and the carrying process (S1) shown in FIG. 11. The label roll 11 is set to the tray part 12 by the user before starting the operation of the print device 1. The print device 1 receives print data and medium length data sent from the higher-level host 9 (YES in S11). The print data and the medium length data received through the host I/F part 304 are stored in the RAM 303, and the medium length data are input to the medium length judgment part 306 (S12). Once the preparation for printing is complete, the motor controller 307 rotates the label roll 11 through the tray part 12 and rotates the carrying roller pair 21 by the power of the drive force generating source such as a motor. Thereby, the label medium 10 is pulled out from the label roll 11, and carrying the label medium 10 is started (S13).

The carrying roller pairs 21 and 22 carry the label medium 10 to the print part 3 (S14). Upon detecting the label medium 10, the print part 3 performs printing based on the print data to the print label 101 (S15). While executing printing, the carrying roller pairs 21 and 22 continue carrying the label medium 10. Also, the motor controller 307 drives the drive force generating source such as a motor to rotate the carrying roller pairs 23 and 24. The carrying roller pairs 23 and 24 also carry the label medium 10 toward the downstream side.

The medium length counter 305 counts the carried amount of the label medium detected by the carried amount sensor 30 (S16). The medium length determination part 306 determines whether the length of the label medium 10 based on the counted carried amount coincides with the length based on the medium length data stored in S2 (S17). If it is determined that the length based on the counted carried amount coincides with the length based on the medium length data (YES in S17), the medium length determination part 306 demands to stop the carrying roller pairs 21, 22, 23, and 24. The motor controller 307 stops driving the drive force generating source such as a motor to stop the rotations of the carrying roller pairs 21, 22, 23, and 24 (S18).

Separation (Cutting) Process

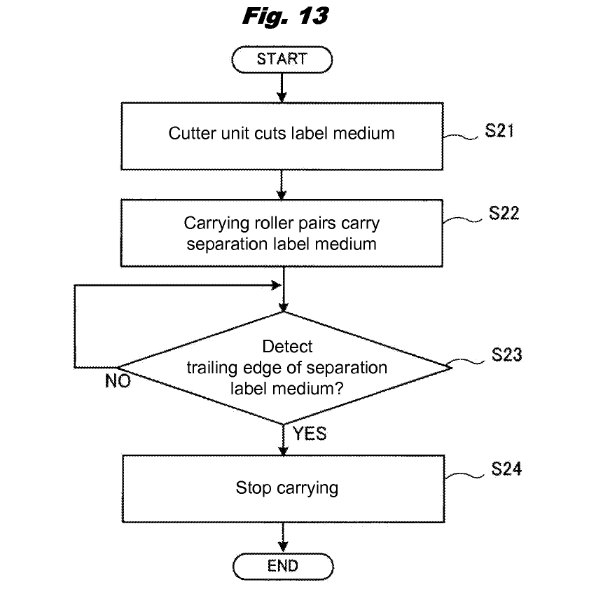

FIG. 13 is a flow chart showing the separating (cutting) process shown in FIG. 11. The cutter unit controller 308 drives the cutter motor 43 to have the upper blade 42 scan. The leading edge side of the label medium 10 is sandwiched and cut between the scanned upper blade 42 and lower blade 44 to be separated as the separation label medium 10a (S21). The carrying roller pairs 23 and 24 carry the separation label medium 10a to the downstream side that is the direction toward the carry-out port 29 (S22). Besides, as shown in FIG. 3, although the opening part 32 is provided between the lower guide members 25 and 27 that constitute the carrying path, the opening part 32 does not obstruct carrying the label medium 10 and the separation label medium 10a. Also, the second adhesive roller 57 and the first adhesive roller 51 are disposed so as not to obstruct carrying the label medium 10 and the separation label medium 10a.

The trailing edge sensor controller 310 determines whether the trailing edge sensor 31 has detected the trailing edge 10b side of the separation label medium 10a (S23). Once it is determined that the trailing edge sensor 31 has detected the trailing edge 10b of the separation label medium 10a (YES in S23), the trailing edge sensor controller 310 demands the motor controller 307 to stop the rotations of the carrying roller pairs 23 and 24. The motor controller 307 stops driving the drive force generating source such as a motor to stop the rotations of the carrying roller pairs 23 and 24 (S24).

Peeling Process

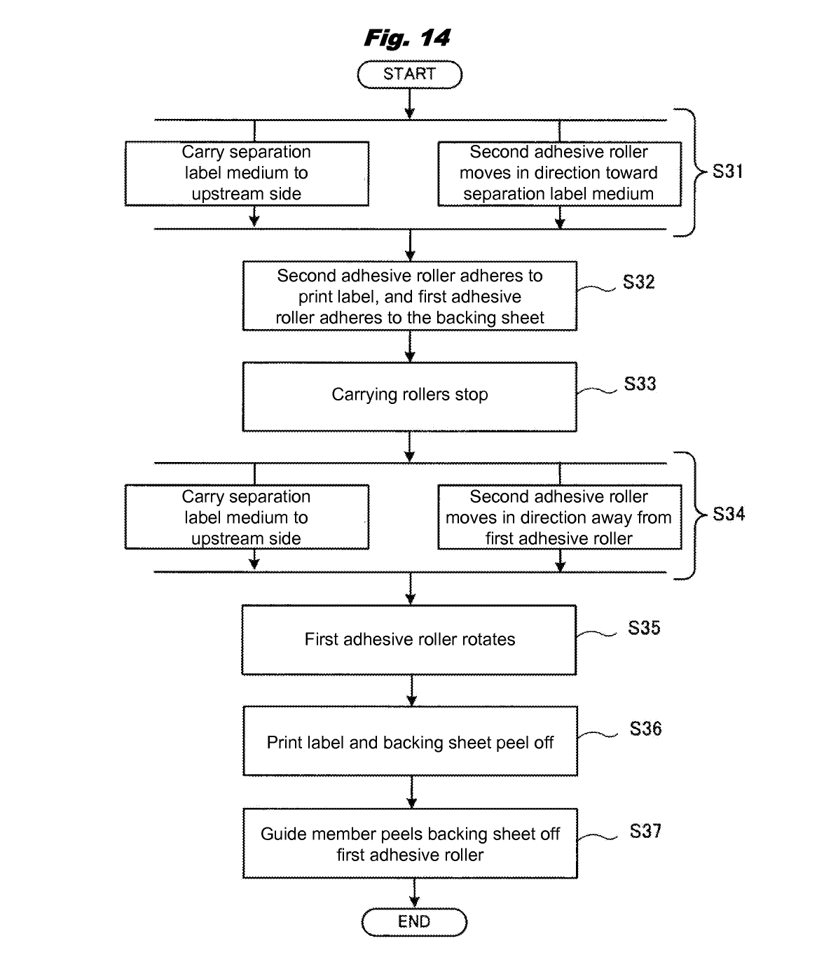

FIG. 14 is a flow chart showing the peeling process (S3) shown in FIG. 11. The peeling process in FIG. 14 is the process shown in FIGS. 4A, 4B, 5A, 5B, 6A, and 6B. The motor controller 307 drives the drive force generating source such as a motor to rotate the carrying roller pairs 23 and 24 so that the separation label medium 10a is carried to the upstream side (in the opposite direction of the carrying direction in the separation label medium carrying process). In parallel with this, the postprocessing controller 309 drives the second peeling motor 61 to move the second adhesive roller 57 toward the first adhesive roller 51 (S31). Afterwards, the second adhesive roller 57 adheres to the print label 101 of the separation label medium 10a, and the first adhesive roller 51 to the backing sheet 102 of the separation label medium 10a (S32). This is because the moving speed of the second adhesive roller 57 and the dispositions of individual configurations are adjusted in advance so that the separation label medium 10a is sandwiched between the second adhesive roller 57 and the first adhesive roller 51 before the second adhesive roller 57 contacts with the first adhesive roller 51.

Next, the motor controller 307 stops driving the drive force generating source such as a motor to stop the rotations of the carrying roller pairs 23 and 24, and the postprocessing controller 309 stops driving the second peeling motor 61 to stop the movement of the second adhesive roller 57 (S33). This is for securing time for the second adhesive roller 57 to adhere to the print label 101 and for the first adhesive roller 51 to adhere to the backing sheet 102 so that the print label 101 and the backing sheet 102 adhere (stick) securely to the adhesive rollers. After a certain period of time passed, the postprocessing controller 309 drive the second peeling motor 61 to move the second adhesive roller 57 in a direction away from the first adhesive roller 51. In parallel with this, the motor controller 307 drives the drive force generating source such as a motor to rotate the carrying roller pairs 23 and 24 so that the separation label medium 10a is carried to the upstream side (S34). Furthermore, the postprocessing controller 309 drives the first peeling motor 55 to rotate the first adhesive roller 51 so that the separation label medium 10a is carried to the upstream side (S35). The second adhesive roller 57 attracts the print label 101 in such a direction as to pull it off the backing sheet 102. Also, the first adhesive roller 51 attracts the backing sheet 102 in such a direction as to pull it off the print label 101. In this manner, a force to peel the print label 101 and the backing sheet 102 off is applied to the separation label medium 10a.

In this manner, the separation label medium 10a is peeled and separates into the print label 101 adhered to the second adhesive roller 57 and the backing sheet 102 adhered to the first adhesive roller 51 (S36). The guide member 56 peels the backing sheet 102 off the first adhesive roller 51 by inserting the tip part 56a between the backing sheet 102 and the first adhesive roller 51 (S37).

Folding Trace Forming Process

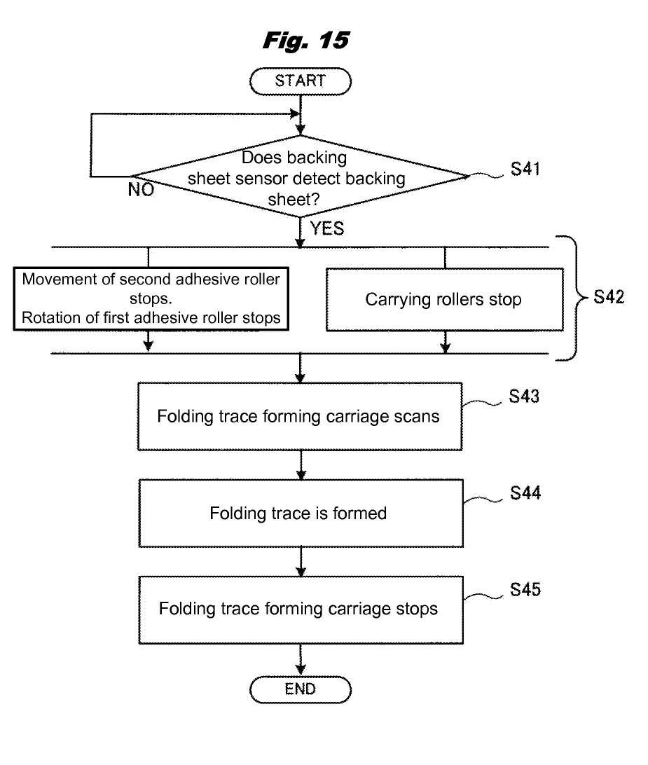

FIG. 15 is a flow chart showing the folding trace forming process (S4) shown in FIG. 11. The folding trace forming process in FIG. 15 is the process shown in FIGS. 7A and 7B. By the rotations of the carry roller pairs 23 and 24 and the rotation of the first adhesive roller 51, the backing sheet 102 is carried until reaching the position opposing the folding trace forming groove 71 of the folding trace forming part 70. Once it is detected that the edge portion (trailing edge portion) of the backing sheet 102 has reached the position of the backing sheet sensor 76 (YES in S41), the postprocessing controller 309 stops driving the first peeling motor 55 to stop the rotation of the first adhesive roller 51, and stops driving the second peeling motor 61 to stop the movement of the second adhesive roller 57. Note that it is also possible to make the timing to stop driving the second peeling motor 61 not to coincide with the timing to stop driving the first peeling motor 55. Also, the motor controller 307 stops driving the drive motor to stop the rotations of the carrying roller pairs 23 and 24 (S42).

Step S41 may be performed when the backing sheet 102 is determined that the sheet has moved a certain distance toward the upstream.

The postprocessing controller 309 drives the carriage motor 74 to have the folding trace forming carriage part 73 scan in the direction along the folding trace forming groove 71 of the lower guide member 25 (S43). The backing sheet 102 is pressed into the concave part between the convex part of the folding trace forming carriage part 73 and the folding trace forming groove 71. Thereby, the backing sheet 102 has a folding trace formed (S44). Once the folding trace forming carriage part 73 moves and is detected by a sensor, the postprocessing controller 309 stops driving the carriage motor 74 and stops the scan by the folding trace forming carriage part 73 (S45).

Ejection Process

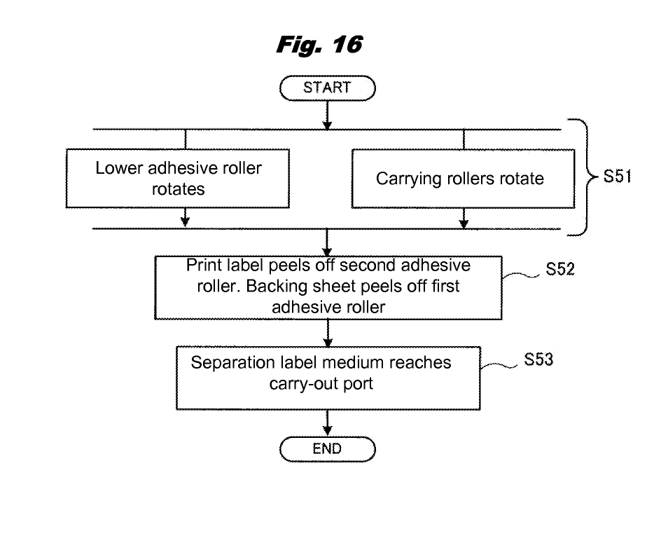

FIG. 16 is a flow chart showing the ejection process (S5) shown in FIG. 11. The ejection process in FIG. 16 is the process shown in FIGS. 8A, 8B, 9A, and 9B. The motor controller 307 drives the drive force generating source such as a motor to rotate the carrying roller pairs 23 and 24 so that the separation label medium 10a is carried toward the carry-out port 29. Also, the postprocessing controller 309 drives the first peeling motor 55 to rotate the first adhesive roller 51 (S51). Thereby, a force toward the downstream side is applied to the separation label medium 10a. By this force, the print label 101 is peeled off the second adhesive roller 57, and the backing sheet 102 is peeled off the first adhesive roller 51 (S52).

The separation label medium 10a is carried to the carry-out port 29 and ejected to the outside of the label medium carrying device 2 in a state that the backing sheet 102 with the folding trace 104 on the trailing edge 10b portion and the print label 101 are superimposed (S53).

### 4. Efficacy of the Embodiment

As explained above, according to this embodiment, the trailing edge peeling part 50 peels the trailing edge portion of the peeling member 102 off the adhesive face 103 of the label member 101 in the trailing edge 10b side of the separation label medium 10a, and the folding trace forming part 70 forms the folding trace 104 on the trailing edge portion of the peeled-off peeling member 102. When the peeling member 102 and the adhesive face 103 of the label member 101 are re-adhered, the folding trace 104 formed on the peeling member 102 is re-adhered to the adhesive face 103 of the label member 101. Because the peeling member 102 is not flat any longer due to the folding trace 104, the adhesive force between the adhesive face 103 of the label member 101 and the peeling member 102 becomes weak. Therefore, the user can easily peel the peeling member 102 of the separation label medium 10a off the label member 101 without scratching the separation label medium 10a.

### 5. Modifications

The above-mentioned embodiment adopts a configuration that, in the peeling process, carrying the separation label medium 10a is switched toward the upstream side, and the second adhesive roller 57 is moved closer to the first adhesive roller 51. However, instead of the configuration that the second adhesive roller 57 is made movable in parallel with carrying the separation label medium 10a, a configuration that the first adhesive roller 51 is moved closer to the second adhesive roller 57 may be adopted. Such a configuration can be realized, for example, by adding a drive part (for example, a drive part including a motor as the drive force generating source and a gear as the transmission mechanism) that moves the first adhesive roller 51. Also, because the folding trace 104 is relatively small, when the backing sheet 102 is re-adhered, the backing sheet 102 can cover the whole of the adhesive face 103 to maintain a state where it is hard for dirt etc. to attach onto the adhesive face 103.

Also, the above-mentioned embodiment adopts a configuration that, in the folding trace forming process, a linear fold is formed as the folding trace 104 on the backing sheet 102 using the folding trace forming groove 71 that is a long groove as the concave part and the pressing member 72 as the convex part. However, the folding trace 104 formed by the folding trace forming process is not limited to a linear fold. For example, as the folding trace forming process, a process to form a wavy fold on the backing sheet 102, a process to form a dotted-line fold (a shape alternating places with a fold and places without a fold) on the backing sheet 102, and a process to form a fold with a perforated cut line (a shape alternating places with a cut and places without a cut) on the backing sheet 102, and the like may be adopted. In this manner, various kinds of shapes can be adopted as the folding trace shape as far as the shape can weaken the adhesive force between the adhesive face 103 of the print label 101 and the trailing edge portion of the backing sheet 102 and allows the adhesive face 103 to be covered when the backing sheet 102 is re-adhered to make it hard for dirt to attach onto the adhesive face 103.

(Folding Trace Forming Part for Label Member)

In contrast with the above embodiments, the folding trace forming part may be disposed in the upstream side of second adhesive roller 57 of the trailing edge peeling part 50. In this alternative embodiment, the folding trace forming part forms a folding trace on the trailing edge portion of print label 101, not on backing sheet 102, peeled off separation label medium 10a. The folding trace forming part is provided with the same components as the above embodiment. The components are, for example, folding trace forming groove 71 as a concave part opposing the trailing edge portion of print label 101 peeled off by trailing edge peeling part 50, and pressing member 72 as a convex part that opposes folding trace forming groove 71 and presses the trailing edge portion of print label 101 into folding trace forming groove 71. Also, the folding trace forming part is provided with folding trace forming carriage part 73, carriage motor 74 as the drive force generating source, and gear 75 as a power transmission mechanism that transmits drive force of carriage motor 74 to folding trace forming carriage part 73. The folding trace forming groove is, for example, a long groove formed on a carrying path of the peeled print label 101, in the vicinity of the second adhesive roller 57. By the trailing edge portion of print label 101 being pressed between pressing member 72 of folding trace forming carriage part 73 and folding trace forming groove 71, the folding trace is formed on print label 101. At this time, folding trace forming carriage part 73 moves (scans) in the direction parallel to the side of the trailing edge of label medium 10 by the drive force of the carriage motor 74 while pressing print label 101 into folding trace forming groove 71.

When the folding trace forming process and method are conducted for the alternative embodiment above, the forming process and the method are generally the same as disclosed in paragraphs [0054] and [0055]. The main difference from them is that forming folding trace step S41 is performed on the trailing edge portion of print label 101.

In FIG. 8A, when separation label medium 10a is peeled, adhesive face 103 is disposed on print label 101. However, the face may be disposed on backing sheet 102.

This invention is not limited to the above-mentioned embodiment but can be modified within a range not deviating from the original purpose.

What is claimed is:

1. A label medium carrying device, comprising:
a medium carrying part that carries a separation label medium configured with a label member having an adhesive face and a peeling member superimposed on the adhesive face,
a trailing edge peeling part that peels the trailing edge portion of the peeling member off the adhesive face in a trailing edge side of the separation label medium, and
a folding trace forming part that forms a folding trace on the trailing edge portion of either the peeling member or the label member that is peeled off by the trailing edge peeling part.

2. The label medium carrying device according to claim 1, wherein
the folding trace forming part forms the folding trace of the trailing edge portion of the peeling member.

3. The label medium carrying device according to claim 1, wherein
the folding trace forming part forms the folding trace of the trailing edge portion of the label member.

4. The label medium carrying device according to claim 1, wherein
the trailing edge peeling part comprises
a first attracting part that attracts the peeling member of the separation label medium in a direction away from the label member, and
a second attracting part that attracts the label member of the separation label medium in a direction away from the peeling member.

5. The label medium carrying device according to claim 4, wherein
the first attracting part comprises
a first adhesive roller in contact with the peeling member of the separation label medium and
a first drive mechanism that rotates the first adhesive roller, and
the second attracting part comprises
a second adhesive roller in contact with the label member of the separation label medium and
a second drive mechanism that moves the second adhesive roller in a direction away from the first adhesive roller.

6. The label medium carrying device according to claim 5, further comprising:
a peeling member guide part that peels the peeling member off the first adhesive roller.

7. The label medium carrying device according to claim 1, wherein
the medium carrying part comprises carrying rollers that carry the separation label medium.

8. The label medium carrying device according to claim 2, wherein
the folding trace forming part comprises
a concave part that opposes the trailing edge portion of the peeling member peeled off by the trailing edge peeling part, and
a convex part that opposes the concave part and presses the trailing edge portion of the peeling member into the concave part so that the folding trace is formed.

9. The label medium carrying device according to claim 8, wherein
the medium carrying part comprises a carrying path that guides the separation label medium, and
the concave part of the folding trace forming part is a groove formed on the face on the opposite side of the face that guides the separation label medium in the carrying path.

10. The label medium carrying device according to claim 2, wherein
the folding trace formed by the folding trace forming part is a bent portion formed on the trailing edge portion of the peeling member so as to direct its apex part toward the label member.

11. The label medium carrying device according to claim 1, wherein
the label member is a print label of which one face is the adhesive face and the other face on the opposite side of the adhesive face is an image print face for image printing, and
the peeling member is a backing sheet having a peeling face on the adhesive face side.

12. The label medium carrying device according to claim 1, wherein
the peeling member and the label member are superimposed again on the adhesive face by the medium carrying part carrying the separation label medium in the ejection direction.

13. The label medium carrying device according to claim 1, further comprising:
a medium separation part that separates a part of the leading edge side in a longitudinal direction of the label medium carried by the medium carrying part, wherein
the separation label medium is the part of the leading edge side of the label medium separated by the medium separation part.

14. A print device, comprising:
a print part that prints images on the label member, and
the label medium carrying device according to claim 13 that carries the label medium.

15. A label medium carrying method executed by a label medium carrying device, comprising:
a carrying step that carries a separation label medium, which is configured with a label member having an adhesive face and a peeling member superimposed on the adhesive face, from an upstream to a downstream of a medium carrying path,
a peeling step that peels a trailing edge portion of the peeling member off the adhesive face of the label member from a trailing edge portion of the separation label medium, and
a folding trace forming step that forms a folding trace on the trailing edge portion of either the peeling member or the label member that is peeled off in the peeling step.

16. The label medium carrying method according to claim 15, wherein
the folding trace is a bent portion formed on the trailing edge portion of the peeling member so as to direct its apex part toward the label member.

17. The label medium carrying method according to claim 15, wherein
the peeling step is performed after the trailing edge portion of the peeling member is detected, and
the peeling step is performed while the separation label medium is carried to the upstream of the medium carrying path.

18. The label medium carrying method according to claim 15, wherein
the folding trace forming step is performed when the trailing edge portion of the peeling member is detected or when the trailing edge portion moves a predetermined amount toward the upstream.

19. The label medium carrying method according to claim 15, wherein
the separation label medium is a single long sheet and is provided in a roll shape,
the label medium carrying method, further comprising:
a medium length data storing step that stores a medium length data determining a length of the label member on which a print is executed in correspondence with print data,
a cutting step that cuts the separation label medium in order to form the trailing edge portion of the separation label member in a middle of the sheet, the cutting step being performed when the separation label member is carried to the same amount as the medium length data and before the peeling step is performed.

20. The label medium carrying method according to claim 15, further comprising:
an ejection step to superimpose the peeling member with the folding trace formed on the adhesive face of the label member again by carrying the separation label medium in an ejection direction.

21. The label medium carrying method according to claim 15, further comprising:
a separation step to separate a part of the leading edge side in a longitudinal direction of the carried label medium, wherein
the separation label medium is a part of the leading edge side of the label medium separated in the separation step.
